(19) United States
(12) Patent Application Publication
(10) Pub. No.: US 2019/0112412 A1
(43) Pub. Date: Apr. 18, 2019

(54) URETHANE FOAM SYSTEM FOR MOLDED ARTICLES

(71) Applicant: JONES & VINING, INC., Brockton, MA (US)

(72) Inventor: Richard L. House, Hartford, ME (US)

(73) Assignee: JONES & VINING, INC., Brockton, MA (US)

(21) Appl. No.: 16/158,444

(22) Filed: Oct. 12, 2018

Related U.S. Application Data
(60) Provisional application No. 62/572,250, filed on Oct. 13, 2017.

(51) Int. Cl. C08G 18/18; C08G 18/48; C08G 18/76; C08G 18/30

(52) U.S. Cl. CPC C08G 18/1825; C08G 18/4812; C08G 2101/0008; C08G 18/302; C08G 18/7664

(57) ABSTRACT

The technology relates to a process for the production of a soft, viscoelastic polyurethane foam system. The process includes forming a reaction mixture the includes a resin blend and at least one isocyanate. The resin blend includes at least one polyol and a catalyst blend. The catalyst blend includes between about 0.5% to about 1.5% of a mixture of 1,4-butanediol and triethylene diamine and between about 0.005% to about 0.25% of bis (2-dimethylaminoethyl) ether. The process also includes mixing the resin blend and the at least one isocyanate at a ratio of between about 18 to about 32 parts of the at least one isocyanate to about 100 parts resin blend.

### CROSS-REFERENCE TO RELATED APPLICATION

This application claims priority to and benefit of U.S. provisional patent application No. 62/572,250 filed Oct. 13, 2017 entitled “Urethane Foam System for Molded Articles,” the entire contents of which in hereby incorporated herein by reference.

### FIELD OF THE TECHNOLOGY

In general, the technology of the present disclosure is directed to processes for producing a polyurethane foam system. More specifically, the technology relates to processes for producing a soft, low-density, viscoelastic or flexible polyurethane foam system designed for articles that are molded, either in a low pressure casting or high pressure injection process.

### BACKGROUND OF THE TECHNOLOGY

Polyurethanes, often merely called urethanes, were first developed in the 1930s and are currently used for a variety of applications, including, for example, footwear, automotive applications and components (e.g., door grips, armrests, and seat restraints), building materials and construction tools (e.g., insulation and ladder bumper products), consumer electronics, medical products, furniture, surface coatings, adhesives, solid plastics, and athletic apparel. Polyurethanes can be formed by reacting an isocyanate, characterized by a (NCO) group, with a polyol, compounds that contain multiple alcohol groups (OH).

The molecular weight or hydroxyl number of the polyol(s) used to produce the polyurethane can be selected so that the resulting polyurethane foam is flexible, semi-flexible, or rigid. For example, for rigid polyurethane foams, a polyol with a hydroxyl number of at least about 150 can be used; for semi-flexible foams, a polyol with a hydroxyl number of between about 50 to about 150 can be used; and for flexible foams, a polyol with a hydroxyl number of about 20 to about 70 can be used.

The specific application for which the polyurethane will be used can also have an effect on the hydroxyl number of the polyol(s) used to produce the polyurethane. For example, for polyurethanes used for molded foams, polyols having a hydroxyl number of about 20 to about 40 can be used; and for polyurethanes used for elastomer applications, polyols having a hydroxyl number of about 20 to about 50 can be used.

The reaction mixture for the production of polyurethane foams also typically includes catalysts and blowing agents. Catalysts, or a mixture of catalysts, are employed in the production of polyurethane foams to increase the rate of urethane formation. Blowing agents are used in the foaming process to create holes in matrix producing cellular materials, such as polyurethane.

### SUMMARY OF THE TECHNOLOGY

The technology provides a process for the production of soft, low-density, viscoelastic or flexible polyurethane foams that allows a wider process latitude with respect to the ratio of isocyanate blend (or at least one isocyanate) to resin blend, which in turn results in a wider range of properties than was previously achievable.

In one aspect, a process for the production of a soft, viscoelastic, flexible polyurethane foam system is disclosed. The process includes forming a reaction mixture that includes a resin blend and at least one isocyanate. The resin blend includes at least one polyol and a catalyst blend. The catalyst blend includes between about 0.5% to about 1.5% of a mixture of 1,4-butanediol and triethylene diamine and between about 0.005% to about 0.25% of bis (2-dimethylaminoethyl) ether. The process also includes mixing the resin blend and the at least one isocyanate at a ratio of between about 18 to about 32 parts of the at least one isocyanate to about 100 parts resin blend. The process can include one or more of the embodiments described herein, in any combination.

In some embodiments, the ratio of the at least one isocyanate to the resin blend can be about 18:100, 19:100, 20:100, 21:100, 22:100, 23:100, 24:100, 25:100, 26:100, 27:100, 28:100, 29:100, 30:100, 31:100 or 32:100. In other embodiments, the ratio of the at least one isocyanate to the resin blend can be about 17:100 or about 33:100.

In one embodiment, the at least one polyol can include between about 53% to about 80% of a 1400 molecular weight glycerine initiated PO/EO trifunctional polyol with hydroxyl number between 25 to 45, between about 9% to about 22% of a 400 molecular weight glycerine initiated PO trifunctional polyol with a hydroxyl number between 300 to 500, and between about 9% and about 22% of a ACN/SN initiated graft polyol with a hydroxyl number between 20 to 30 and a solid content between 20% to 50%.

In another embodiment, the at least one isocyanate includes between about 40% to about 60% of a polyester-based prepolymer with an NCO content between about 16% to about 20% with a functionality of 2.0, and between about 40% to about 60% of a polymeric MDI with an NCO content between about 28% to about 34% with a functionality of 2.7.

In some embodiments, the resin blend can also include at least one blowing agent. In some embodiments, the resin blend includes water.

In another aspect, a process for the production of a soft, viscoelastic polyurethane foam system is disclosed. The process includes forming a reaction mixture including a resin blend and an isocyanate blend. The resin blend includes a polyols blend and a catalyst blend. The polyols blend includes between about 53% to about 80% of a 1400 molecular weight glycerine initiated PO/EO trifunctional polyol with hydroxyl number between 25 to 45, between about 9% to about 22% of a 400 molecular weight glycerine initiated PO trifunctional polyol with a hydroxyl number between 300 to 500, and between about 9% to about 22% of a ACN/SN initiated graft polyol with a hydroxyl number between 20 to 30 and a solid content between about 20% to about 50%. The catalyst blend includes between about 0.5% to about 1.5% of a mixture of 1,4-butanediol and triethylene diamine and between about 0.005% to about 0.25% of bis (2-dimethylaminoethyl) ether. The isocyanate blend includes between about 40% to about 60% of a polyester-based prepolymer with an NCO content between about 16% to about 20% with a functionality of 2.0 and between about 40% to about 60% of a polymeric MDI with an NCO content between about 28% to about 34% with a functionality of 2.7. The process also includes reacting the reaction mixture under suitable conditions to form a polyurethane foam system. The process can include one or more of the embodiments described herein, in any combination.

The resin blend can include at least one blowing agent. In one embodiment, the resin blend includes water.

In one embodiment, forming the reaction mixture includes mixing the resin blend and the isocyanate blend at a ratio of between about 18 to about 32 parts isocyanate blend to about 100 parts resin blend. In other embodiments, the ratio of the at least one isocyanate to the resin blend can be about 18:100, 19:100, 20:100, 21:100, 22:100, 23:100, 24:100, 25:100, 26:100, 27:100, 28:100, 29:100, 30:100, 31:100 or 32:100. In other embodiments, the ratio of the at least one isocyanate to the resin blend can be about 17:100 or about 33:100.

### BRIEF DESCRIPTION OF THE DRAWINGS

FIG. 1 is a flow diagram of a process for the production of a soft, viscoelastic polyurethane foam system, according to an illustrative embodiment of the technology.

FIG. 2 is a flow diagram of a process for the production of a soft, viscoelastic polyurethane foam system, according to an illustrative embodiment of the technology.

### DETAILED DESCRIPTION

In accordance with the present technology, a process for the production of polyurethane foams is provided, whereby soft, low-density, viscoelastic or flexible polyurethane foam systems are produced. The foams can be designed for articles that are molded, either in a low pressure casting or high pressure injection process. The articles that the foams are designed for can have a flexible abrasion resistant non-toxic in-mold coating. The in-mold coating can be either a single or multi-component acrylic, polyurethane, epoxy, latex, or other paint material. The articles can have an integrally incorporated attachment mechanism.

The resultant foam system can be used in foam articles such as helmet liners, personal care products, wrist straps or any item in which the foam provides cushioning for comfort or function.

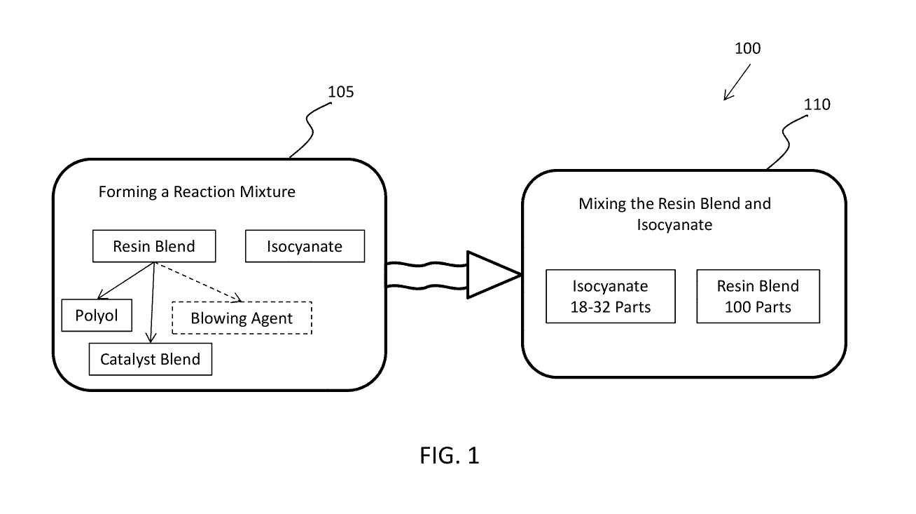

A process 100 for making a polyurethane foam system is shown in FIG. 1. The process 100 includes forming a reaction mixture (105) including a resin blend and at least one isocyanate (or an isocyanate blend). The resin blend can be a blend of polyols, urethane catalysts and blowing agents. To form a soft, low-density, viscoelastic or flexible polyurethane foam system, the resin blend can include three polyols, two catalysts and water. Water can be used as the blowing agent. In addition, a colorant can be added to the resin blend to add a color to the resulting polyurethane foam system.

The polyols blend can include three polyols. The first polyol can be between about 52% to about 80% of a 1400 molecular weight glycerine initiated PO/EO (propylene oxide/ethylene oxide) trifunctional polyol with a hydroxyl number between 25 and 45. The second polyol can be between about 9% to about 22% of a 400 molecular weight glycerine initiated PO (propylene oxide) trifunctional polyol with a hydroxyl number between 300 and 500. The third polyol can be between about 9% to about 22% of a ACN/SN (acetonitrile/tin) initiated Graft polyol with a hydroxyl number between 20 and 30 and a solids content between about 20% to about 50%. This blend of polyols, two of which have relatively low hydroxyl numbers (i.e., between 20 and 45), is one reason why the resultant polyurethane foam is soft, viscoelastic, and flexible. However, other polyols with similarly low hydroxyl numbers known to those of skill in the art can be used in place of or in addition to the polyols blend described above to form a soft, viscoelastic or flexible polyurethane foam system.

The resin blend also includes two urethane catalyst packages. The first urethane catalyst package is between about 0.5% to about 1.5% of the resin blend and is a mixture of 1,4-butanediol and triethylene diamine. This first catalyst package is a gelling catalyst and drives the gelation of the resulting polyurethane foam. The second urethane catalyst package is a blowing catalyst between about 0.005% to about 0.25% of the resin blend and is bis (2-dimethylaminoethyl) ether. For example, bis (2-dimethylaminoethyl) ether can be about 0.1% of the resin blend. Other polyurethane foam catalysts are known to those of skill in the art and can be used in place of or in addition to the catalysts mentioned above. For example, in some embodiments, a curing catalyst can also be used in addition to the catalysts referenced above. The curing catalyst can be between about 0.005% to about 1% of the resin blend.

The resin blend also includes a blowing agent. The blowing agent can be water. The blowing agent/water content is between about 1.00 to about 2.00% of the resin blend. The blowing agent provides the basis for foam expansion by its reaction with the isocyanate blend and generation of carbon dioxide. Other blowing agents are known to those of skill in the art and can be used in place of or in addition to the blowing agent mentioned above.

The isocyanate blend of the reaction mixture can include two isocyanate materials. The first is between about 40% to about 60% of the isocyanate blend and is a polyester based prepolymer with an NCO content between about 16% to about 20% with a functionality of 2.0. The second is between about 40% to about 60% of the isocyanate blend and is a polymeric MDI (PMDI) (polymeric diphenylmethane diisocyanate) with an NCO content between about 28% to about 34% with a functionality of 2.7. Other isocyanates are known to those of skill in the art and can be used in place of or in addition to the isocyanates mentioned above.

Referring to FIG. 1, the resin blend and the isocyante (which includes at least one isocyante or a blend of isocyanates) are mixed (110). The mixing techniques used can entrain air within the resin and can require nucleation of air bubbles within the liquid blend. The resin blend and isocyanate blend can be mixed at ratios of isocyanate blend to resin blend of between about 18 to about 32 parts isocyanate blend to about 100 parts resin blend. The ratio of the isocyanate blend to the resin blend can be about 18:100, 19:100, 20:100, 21:100, 22:100, 23:100, 24:100, 25:100, 26:100, 27:100, 28:100, 29:100, 30:100, 31:100, 32:100 or any other ratio in between, including, fractional ratios, for example, 18.2:100. The ratio of the isocyanate (or isocyanate blend) to the resin blend can determine the viscoelastic properties, or the flexibility and softness, of the resulting polyurethane foam. The lower the ratio of the isocyanate blend to the resin blend, the more viscoelastic the resulting polyurethane foam.

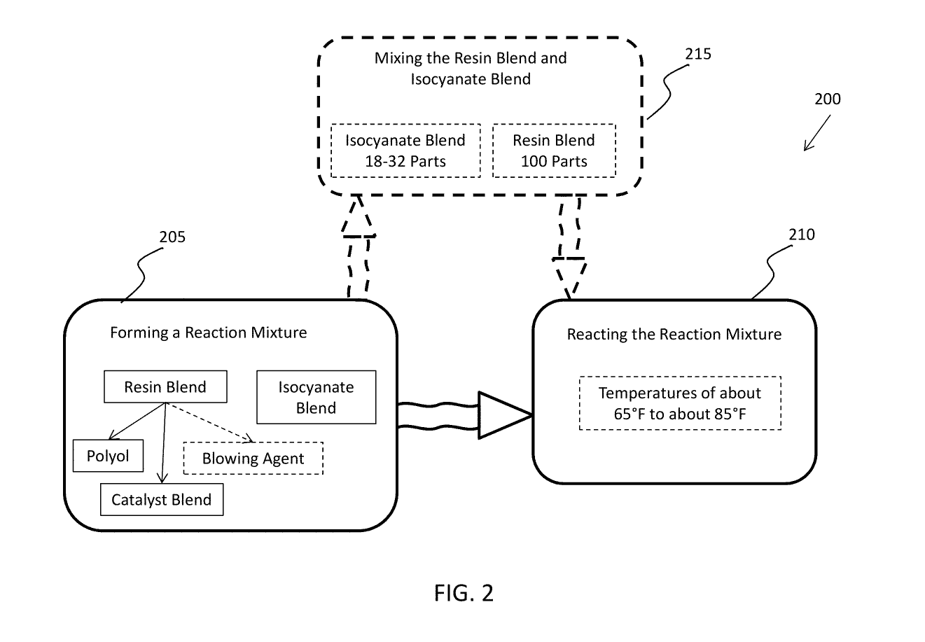

FIG. 2 shows a process 200 for making a polyurethane foam system. The process includes forming a reaction mixture (205) that includes a resin blend and at least one isocyanate or isocyanate blend, as described in detail above. The process 200 also includes reacting the reaction mixture (210). The reaction of the two liquid components is carried out under suitable conditions known to those of skill in the art to form a polyurethane foam system. For example, the process 200 can occur at room temperature, about 65° F. to about 85° F.

In some embodiments, the process 200 also includes mixing the resin blend and the at least one isocyante (215) at a ratio of between 18 to 32 parts isocyanate to 100 parts resin blend, as described in detail above.

Several polyurethane foams were made with various ratios of isocyanate blend to resin blend ranging from 18.2 to 31.2 parts isocyanate blend to 100 parts resin blend. The resultant polyurethane foams were measured for density, or the mass per unit volume. The density of the resultant polyurethane foam was about 0.22 g/cc regardless of the ratio of isocyanate blend to resin blend that was used to make the polyurethane foam.

Next, the resultant polyurethane foams were measured for Shore hardness, or Shore OO. A durometer scale was used, which outputs values between 0 and 100. Higher values of Shore OO indicate a harder material. The resultant polyurethane foam had a Shore OO that ranged between 0 to 20, and generally increased as the ratio of isocyanate blend to resin blend that was used to make the polyurethane foam increased. In other words, a polyurethane foam formed with a ratio of 18.2 parts isocyanate blend to 100 parts resin blend is softer than a polyurethane foam formed with a ratio of 31.2 parts isocyanate blend to 100 parts resin blend.

The ultimate tensile strength of the resultant polyurethane foams was also measured. Tensile strength is a measure of the capacity of a material or structure to withstand tension, or loads that tend to elongate (pull apart) the material. The tensile strength of the material increased as the ratio of isocyanate blend to resin blend increases, and in general was within the range of 9 psi to 35 psi. In other words, a polyurethane foam formed with a ratio of 31.2 parts isocyanate blend to 100 parts resin blend is able to withstand greater tension than a polyurethane foam formed with a ratio of 18.2 parts isocyanate blend to 100 parts resin blend.

The elongation of the resultant polyurethane foams was also measured. Elongation is measured by applying tensile force, or stretching the material, and measuring the change in length of the material from the original. Elongation is expressed as a percentage of the original length. In general, the elongation of the material decreases as the ratio of isocyanate blend to resin blend increases, and in general was between about 450% to about 100%.

The tear strength (Die C Tear) of the resultant polyurethane foams was also measured. Tear strength is a measure of how well a material can withstand tearing, or breaking a material by force without using a cutting tool. The tear strength of the material generally increases as the ratio of isocyanate blend to resin blend increases, and in general was between about 1 lb/in to about 3.5 lb/in.

Finally, the compression set of the resultant polyurethane foams was measured. The compression set is a measurement of the permanent deformation remaining in a material when a force that was previously applied to the material is removed. There is no correlation between the compression set and the ratio of isocyanate blend to resin blend, but in general, the compression set was between about 0.25% to about 2%.

The formulation of the resin blend and isocyanate blend described herein has several advantages over the prior art. The first advantage is that this formulation allows for wider process latitude with respect to the ratio of isocyanate blend to resin blend. Prior to Applicant's invention, the ratio of isocyanate blend to resin blend using prior art formulations and methods was between about 22 to about 29 parts isocyanate blend to about 100 parts resin blend. As described through the specification, the ratio of isocyanate blend to resin blend using Applicant's invention can be anywhere from about 18 to about 32 parts isocyanate blend to 100 parts resin blend. This is a wider range than previously achievable with prior art formulations.

In addition, the formulation of the resin blend and isocyanate blend described herein allows for a wider range of properties than previously achievable. Therefore, a person can use the same formulation for the isocyanate blend and resin blend and merely vary the ratio of isocyanate blend to resin blend to achieve varying physical properties of the resultant polyurethane foam. This has many advantages known to those of skill in the art, including requiring less materials to stock to create polyurethane foams with different physical properties. In addition, the formulation allows for certain properties of the polyurethane foam to be tailored, with respect to tensile strength while having little effect of compression set.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with reference to particular embodiments thereof, those of ordinary skill in the art will understand that various substitutions and alterations in form and detail may be made therein without departing from the scope of the invention. Further still, other aspects, functions and advantages are also within the scope of the invention.

What is claimed is:

1. A process for the production of a soft, viscoelastic polyurethane foam system, comprising:
(a) forming a reaction mixture comprising
a resin blend comprising
at least one polyol;
a catalyst blend consisting essentially of
between 0.5% to 1.5% of a mixture of 1,4-butanediol and triethylene diamine; and
between 0.005% to 0.25% of bis (2-dimethylaminoethyl) ether; and
at least one isocyanate; and
(b) mixing the resin blend and the at least one isocyanate at a ratio of between 18 to 32 parts of the at least one isocyanate to 100 parts resin blend.

2. The process of claim 1, wherein the at least one polyol comprises
between 53% to 80% of a 1400 molecular weight glycerine initiated PO/EO trifunctional polyol with hydroxyl number between 25 to 45;
between 9% to 22% of a 400 molecular weight glycerine initiated PO trifunctional polyol with a hydroxyl number between 300 to 500; and
between 9% and 22% of a ACN/SN initiated graft polyol with a hydroxyl number between 20 to 30 and a solid content between 20% to 50%.

3. The process of claim 1, wherein the at least one isocyanate comprises
between 40% to 60% of a polyester-based prepolymer with an NCO content between 16% to 20% with a functionality of 2.0; and
between 40% to 60% of a polymeric MDI with an NCO content between 28% to 34% with a functionality of 2.7.

4. The process of claim 1, wherein the resin blend further comprises at least one blowing agent.

5. The process of claim 1, wherein the resin blend further comprises water.

6. A process for the production of a soft, viscoelastic polyurethane foam system, comprising:
(a) forming a reaction mixture comprising
a resin blend comprising
a polyols blend consisting essentially of
between 53% to 80% of a 1400 molecular weight glycerine initiated PO/EO trifunctional polyol with hydroxyl number between 25 to 45;
between 9% to 22% of a 400 molecular weight glycerine initiated PO trifunctional polyol with a hydroxyl number between 300 to 500; and
between 9% and 22% of a ACN/SN initiated graft polyol with a hydroxyl number between 20 to 30 and a solid content between 20% to 50%; and
a catalyst blend consisting essentially of
between 0.5% to 1.5% of a mixture of 1,4-butanediol and triethylene diamine; and
between 0.005% to 0.25% of bis (2-dimethylaminoethyl) ether; and
an isocyanate blend consisting essentially of
between 40% to 60% of a polyester-based prepolymer with an NCO content between 16% to 20% with a functionality of 2.0; and
between 40% to 60% of a polymeric MDI with an NCO content between 28% to 34% with a functionality of 2.7; and
(b) reacting the reaction mixture under suitable conditions to form a polyurethane foam system.

7. The process of claim 6, wherein the resin blend further comprises at least one blowing agent.

8. The process of claim 6, wherein the resin blend further comprises water.

9. The process of claim 6, wherein forming the reaction mixture further comprises mixing the resin blend and the isocyanate blend at a ratio of between 18 to 32 parts isocyanate blend to 100 parts resin blend.
